(19) United States
(12) Patent Application Publication
(10) Pub. No.: US 2010/0206270 A1
(43) Pub. Date: Aug. 19, 2010

(54) HYDRAULIC SUPPLY FOR A VARIABLE COMPRESSION RATIO ENGINE

(76) Inventor: Vianney Rabhi, Lyon (FR)

Correspondence Address: YOUNG & THOMPSON, 209 Madison Street, Suite 500, Alexandria, VA, 22314, US

(21) Appl. No.: 12/669,065

(22) PCT Filed: Jul. 18, 2008
(86) PCT No.: PCT/FR08/01059

§ 371 Date: Jan. 14, 2010

Related U.S. Application Data
(60) Provisional application No. 60/971,275, filed on Sep. 11, 2007.

(30) Foreign Application Priority Data
Jul. 19, 2007 (FR) 0705237

(51) Int. Cl. F02D 15/02

(52) U.S. Cl. 123/48 B

(57) ABSTRACT

The hydraulic supply for a variable compression ratio engine includes a compressed-air oil pressure accumulator (251), connected to a multi-stage pressure amplifier (241) having at least one stage the outlet pressure of which acts upon the pressure jack(s) (170) of the engine, the outlet pressure being controlled by at least one stage selector solenoid (285), and connected to the control jack(s) (8).

The present invention relates to a hydraulic unit for a variable compression ratio engine comprising a compressed air oil pressure accumulator and a multi-stage pressure amplifier provided with at least one stage allowing the pressure applied to the pressing actuators of said engine to be regulated, during operation, and with a low energy consumption.

International patents WO 98/51911, WO 00/31377, WO 03/008783 in the name of the same applicant disclose various mechanical devices for a variable cylinder-capacity engine.

It will be noticed that international patent WO 98/51911 in the name of the same applicant describes a device used to improve the efficiency of internal combustion piston engines used at variable speed and load by adapting their effective cylinder capacity and/or their compression ratio while they are running. Because this type of engine is known to those skilled in the art by the name of “variable compression ratio engine”, it is that term that will be used in the text which follows.

It will be observed that, according to international patent WO 00/31377 in the name of the same applicant, the mechanical transmission device for a variable compression ratio engine comprises a piston secured at its lower part to a transmission member collaborating, on the one hand, with an antifriction guide device and, on the other hand, with a cogged wheel secured to a link rod transmitting movement between said piston and said link rod.

It will be noted that, according to international patent WO 03/008783 in the name of the same applicant, the mechanical transmission device for a variable compression ratio engine comprises at least one cylinder in which there moves a piston which is secured at its lower part to a transmission member collaborating, on the one hand, by means of a small-sized rack, with an antifriction guide device and, on the other hand, by means of a large-sized other rack, with a cogged wheel secured to a link rod. Said mechanical transmission device for a variable compression ratio engine also comprises at least one control rack collaborating with the cogged wheel, means of attaching the piston to the transmission member which apply a clamping preload, connecting means able to stiffen the teeth of the racks, and means of reinforcing and lightening the structure of the cogged wheel.

It will be noted that the minimum operating clearance between the tooth sets of the large-sized racks and those of the cogged wheels is fixed by the location of rolling surfaces created on said large-sized racks and said cogged wheel.

It will be noted that, according to patent application FR 2 896 539, the variable compression ratio engine has at least one pressing actuator which allows the rolling surfaces to remain permanently in contact with one another in order to keep control over the acoustic emissions of said engine and increase the manufacturing tolerances on the crank case thereof.

It will also be noted that, according to patents WO 98/51911 and FR 2 896 539, the vertical position of the rack controlling the variable compression ratio engine is controlled by a control actuator which comprises a inlet for hydraulic fluid under pressure designed to compensate for any leaks from said control actuator, and to provide a preloading pressure aimed at increasing the precision with which the vertical position datum of said control actuator is maintained by reducing the effects of the compressibility of the oil, and aimed at avoiding any phenomenon of cavitation within the chambers of said actuator.

It will be noted that the variable compression ratio engine has as many pressing actuators and control actuators as it has cylinders.

As claimed in French patent application FR 2 896 539 in the name of the same applicant, the variable compression ratio engine comprises a hydraulic unit designed, on the one hand, to provide its pressing actuator(s) with the hydraulic pressure needed for operation thereof and, on the other hand, to provide its control actuator(s) with the hydraulic pressure needed to compensate for any hydraulic leaks therefrom and increase the precision thereof.

It will be noticed, according to French patent application FR 2 896 539 in the name of the same applicant, that the hydraulic pressure supplied to the control actuator may also be used to increase the rate of travel of said control actuator during operations aimed at increasing the compression ratio of the variable compression ratio engine. According to this last alternative form, said hydraulic pressure is applied to the upper face of the upper rod of the control actuator by means of a chamber formed in the cylinder head of said actuator.

It will be noted that, in French patent application FR 2 896 539 in the name of the same applicant, the hydraulic unit comprises a first pressure accumulator known as the “master” accumulator, said accumulator being fed via a hydraulic pump and constituting a reserve of oil under high pressure.

According to that same patent, the hydraulic unit also comprises a second pressure accumulator known as the “slave” accumulator connected to the hydraulic pressing actuator(s) of the variable compression ratio engine. It will be noted that the mean pressure of said slave accumulator is regulated in order to meet the operating conditions of said engine, by means of hydraulic charging and dump valves. It will be observed that the charging valve allows oil to be transferred from the master accumulator to the slave accumulator in order to increase the pressure therein, while the dump valve allows oil to be transferred from the slave accumulator to the sump containing the lubricating oil of the variable compression ratio engine in order to lower the pressure in said slave accumulator.

Still according to French patent application FR 2 896 539 in the name of the same applicant, it will be observed that the hydraulic unit comprises a third pressure accumulator known as the “leak compensation” accumulator connected to the control actuators of the variable compression ratio engine, the pressure in said leak compensation accumulator being kept approximately constant by a hydraulic expander which is able to supply said leak compensation accumulator with oil, said oil coming from the master accumulator.

The hydraulic unit according to the invention is designed to solve a series of problems associated with the hydraulic unit as described in French patent FR 2 896 539 in the name of the same applicant, these including:
the hydraulic unit as described in French patent FR 2 896 539 requires three pressure accumulators, which increases the cost, weight and size of the variable compression ratio engine,
   the spring-loaded pressure accumulators as described in patent application FR 2 896 539 are robust and durable but have the disadvantage of a high stiffness leading to substantial variations in pressure in the control actuators when these move to regulate the compression ratio of the variable compression ratio engine or in the pressing actuators when these move to accompany the movement of the moving parts of said engine. Furthermore, in order to achieve a low stiffness of said spring-loaded pressure accumulators, it is necessary to increase their size and weight which means that they become too heavy and difficult to house in the sump of said engine. When this happens, it may also be pointed out that any change to the internal pressure of said accumulators, needed notably to control the pressure applied to the pressing actuators as a function of the speed and load of the variable compression ratio engine, leads to a substantial loss in energy because of the substantial qualities of pressurized oil that have to be introduced into said accumulators or removed from said accumulators.
   Pressurized-gas accumulators containing a pressurized gas separated from the hydraulic fluid by a membrane, as described in patent application FR 2 896 539 have a low stiffness, which is advantageous, but on the other hand have the disadvantage of not being sufficiently durable. Specifically, in the present state of the art, the rubber or polymer membranes they incorporate become porous and degrade rapidly which means that it is impossible for them to give reliable service throughout the life of the variable compression ratio engine.
   According to French patent application FR 2 896 539, pressure in the pressing actuators is regulated by means of two valves, one allowing oil to be transferred from the high-pressure master accumulator to the slave accumulator to increase the pressure in the pressing actuators, and the other allowing oil to be transferred from the slave accumulator to the engine oil sump in order to reduce the pressure in the pressing actuators. This way of regulating the pressure in the pressing actuators has the disadvantage of consuming a great deal of energy and of requiring rapid and precise electrically operated valves, the cost of which is high.

It is in order to solve various problems associated with the hydraulic unit of the variable compression ratio engine as described in French patent FR 2 896 539, notably those associated with the excessive size of some of the components of said unit or their inadequate durability and reliability, and those associated with insufficient energy efficiency or excessively high discrepancies between the pressure datum demanded of said unit for the control actuators and the pressing actuators and the actual pressure that said unit is able to deliver to said actuators that the hydraulic unit according to the invention has:
a smaller size so that said unit according to the invention can be fully or partially housed in the sump of the variable compression ratio engine without the need to significantly increase the capacity of said sump;
a low weight, notably because it does not include any spring-loaded pressure accumulators deemed to be heavy, stiff and bulky, said low weight allowing the variable compression ratio engine to be lightened;
just one pressure reserve, rather than three as was the case in French patent FR 2 896 539 in the name of the same applicant, said reserve being of low stiffness and offering, on the one hand, low variations in pressure in the control actuators as a function of the variations in compression ratio and offering, on the other hand, low variations in pressure in the pressing actuators as a function of the amplitude of the operating travel of said pressing actuators resulting from defects in the geometry of the moving linkages and/or of the crank case of the variable compression ratio engine;
long life, notably thanks to the use of just one compressed air pressure accumulator containing no membrane deemed to be fragile and of short life;
good robustness and a modest cost price, notably in that it does not call for high-precision electrically operated valves deemed to be expensive and which incorporate delicate mechanical, electrical or electronic components.

The hydraulic unit for a variable compression ratio engine according to the present invention comprises a compressed air oil pressure accumulator connected, on the one hand, to the inlet of a multi-stage pressure amplifier comprising at least one stage and the outlet pressure of which is applied to the pressing actuator(s) of said engine said outlet pressure being controlled by at least one electrically operated valve, and connected, on the other hand, to the control actuator(s) of said engine.

The hydraulic unit for a variable compression ratio engine according to the present invention has other essential features which are described and protected in the secondary claims which are directly or indirectly dependent on the main claim.

The description which will follow with reference to the attached drawings given by way of nonlimiting examples will enable a better understanding of the invention, of the features it has to offer and of the advantages that it is able to afford:

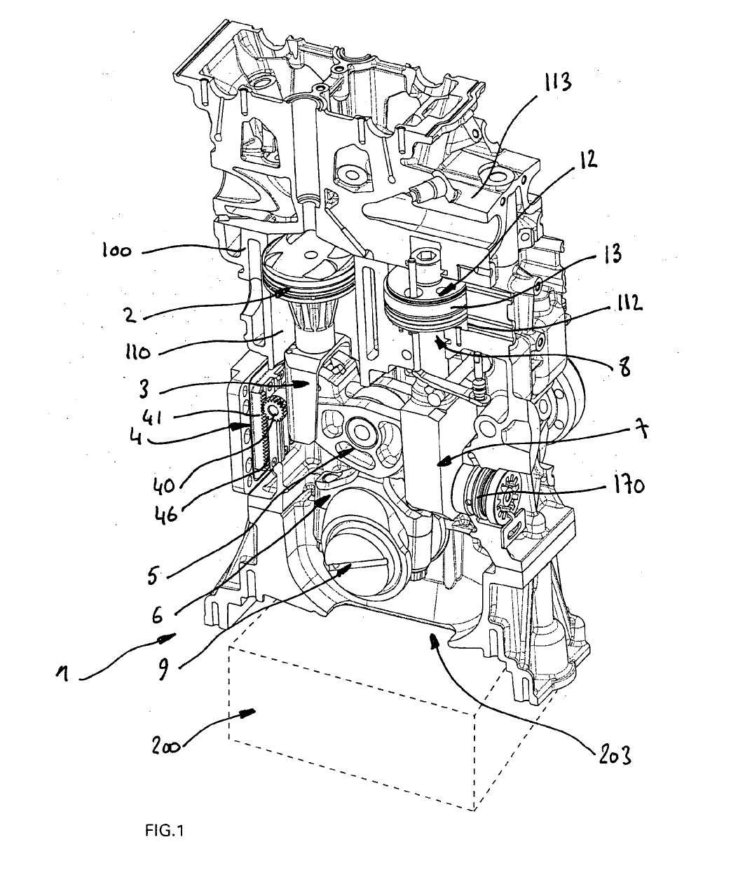

FIG. 1 is a perspective view illustrating the main components of a variable compression ratio engine and the location of the hydraulic unit according to the present invention within said engine.

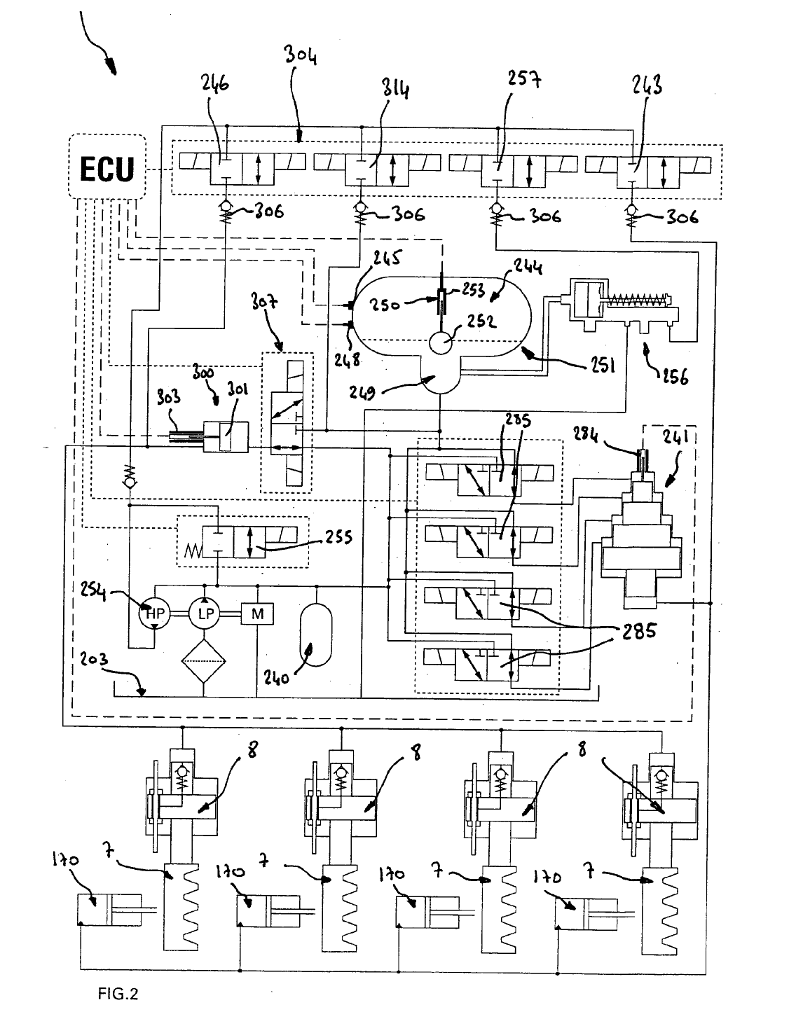

FIG. 2 illustrates the operating diagram of the hydraulic unit for a variable compression ratio engine comprising a compressed air oil pressure accumulator and a multi-stage pressure amplifier provided with at least one stage allowing the pressure applied to the pressing actuators of said engine to be regulated, under running conditions, and with a low energy consumption.

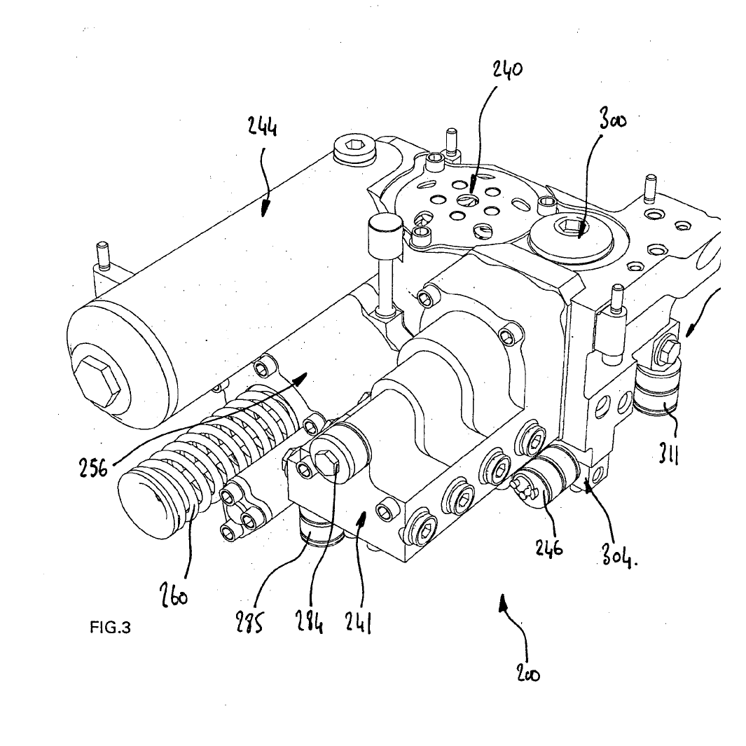

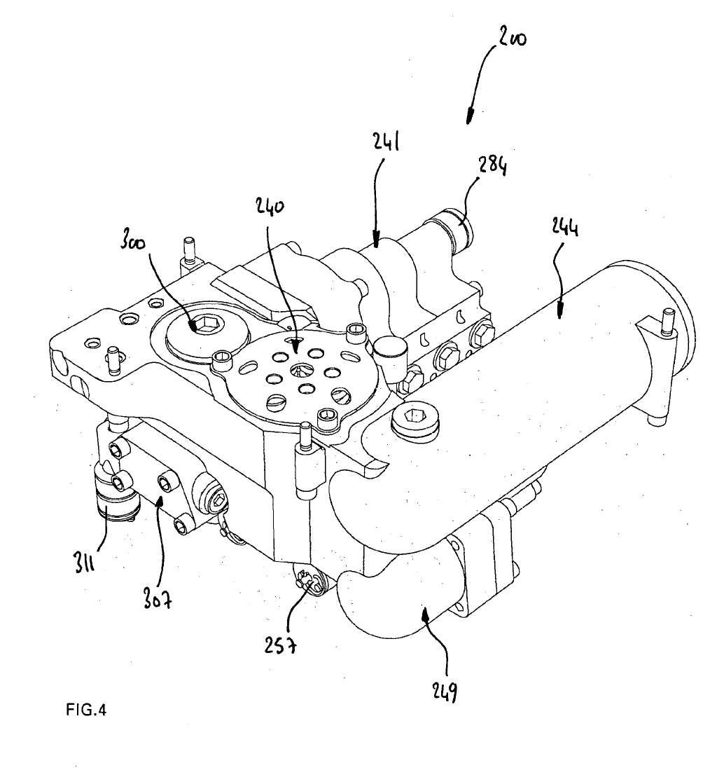

FIGS. 3 and 4 are perspective views showing one example of the layout of the various elements that make up the hydraulic unit for a variable compression ratio engine according to the present invention.

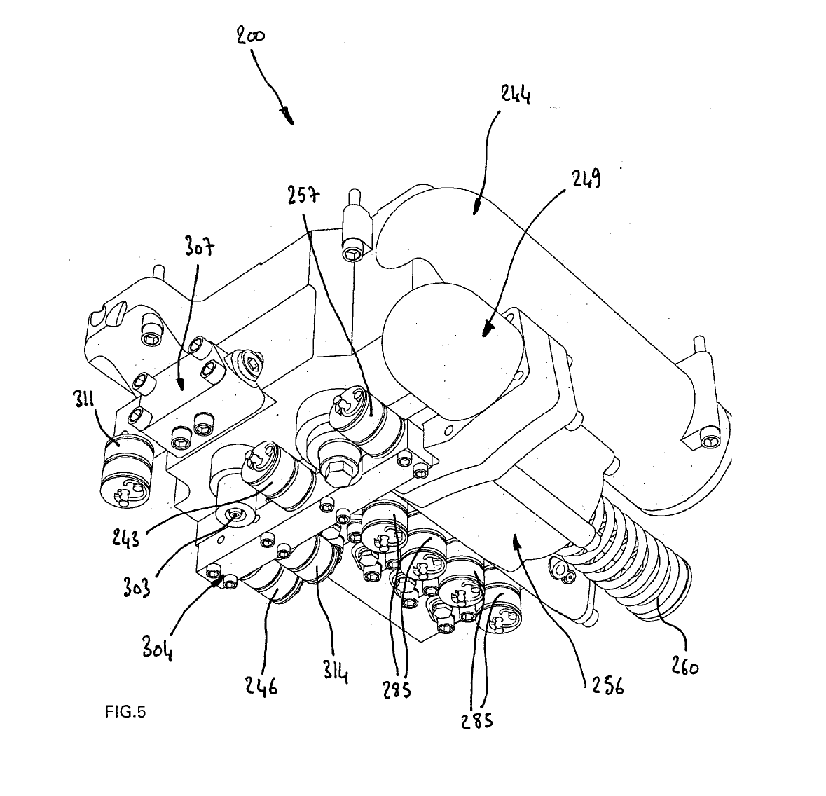

FIG. 5 is a view from beneath illustrating the hydraulic unit for a variable compression ratio engine according to the present invention.

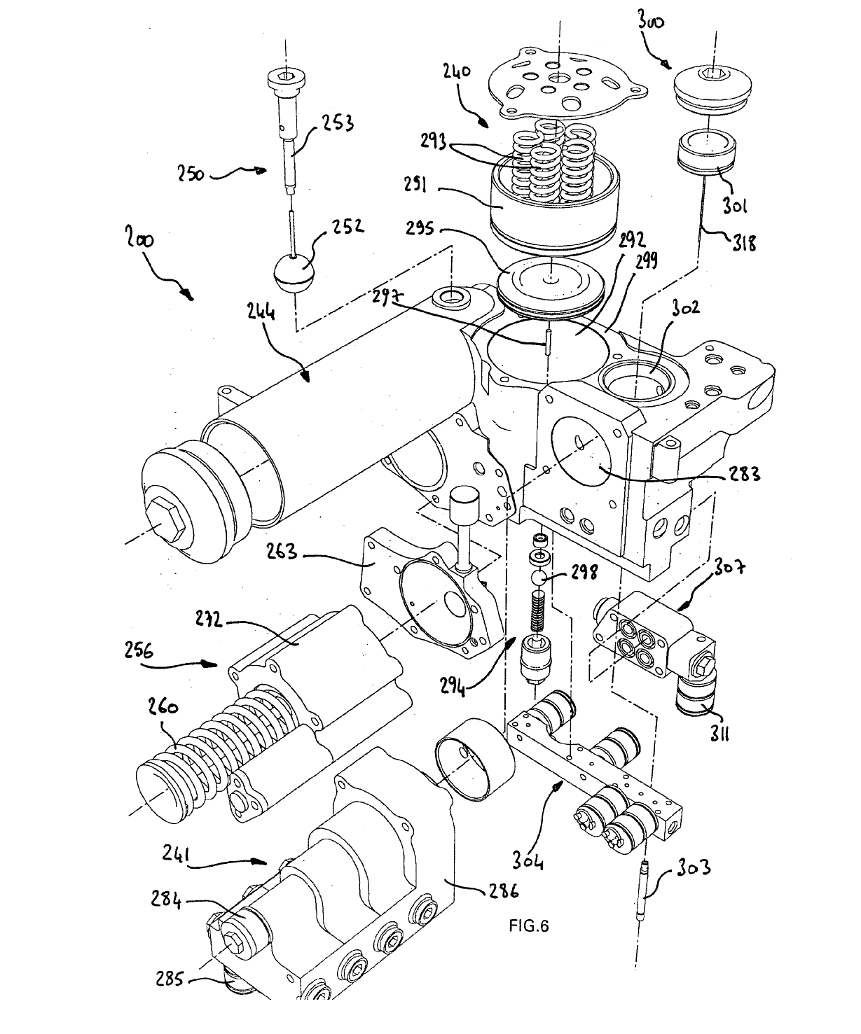

FIG. 6 is an exploded perspective view depicting the various elements of the hydraulic unit for a variable compression ratio engine according to the present invention.

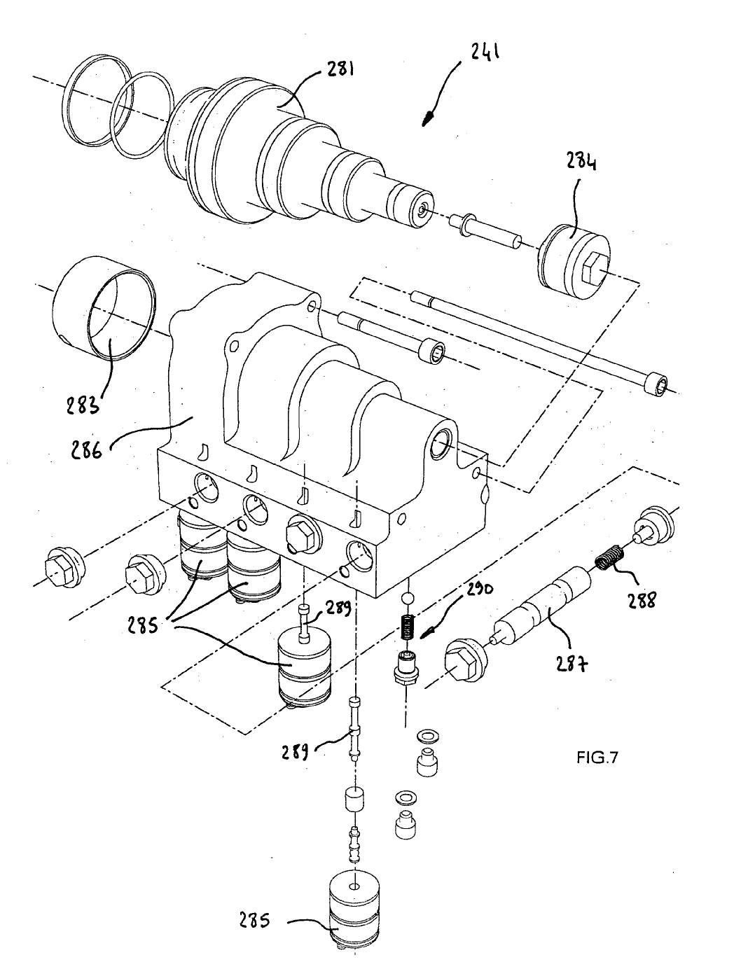

FIG. 7 is an exploded perspective view showing the multi-stage pressure amplifier of the hydraulic unit for a variable compression ratio engine according to the present invention.

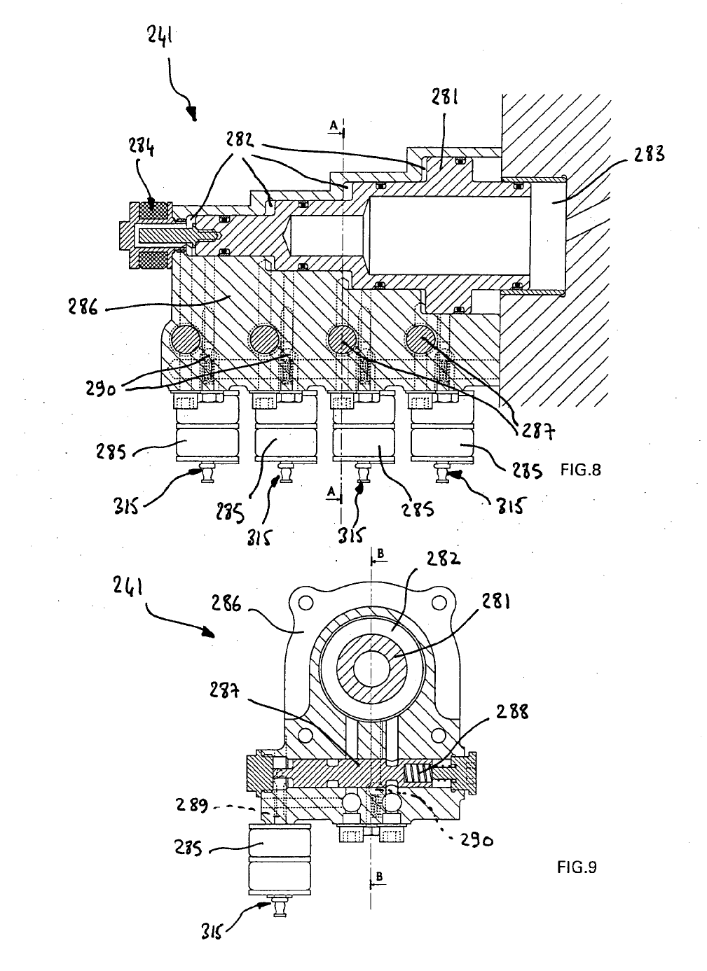

FIGS. 8 and 9 are, respectively, a longitudinal section and a transverse section illustrating the multi-stage pressure amplifier of the hydraulic unit for a variable compression ratio engine according to the present invention.

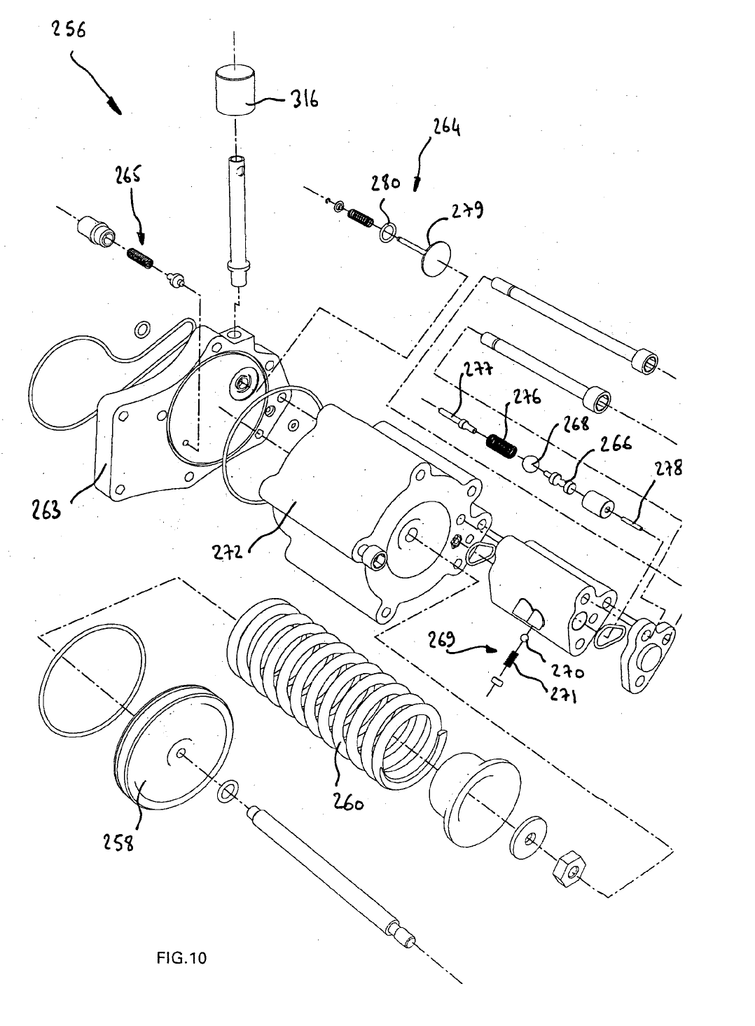

FIG. 10 is an exploded perspective view depicting the air pump of the hydraulic unit for a variable compression ratio engine according to the present invention.

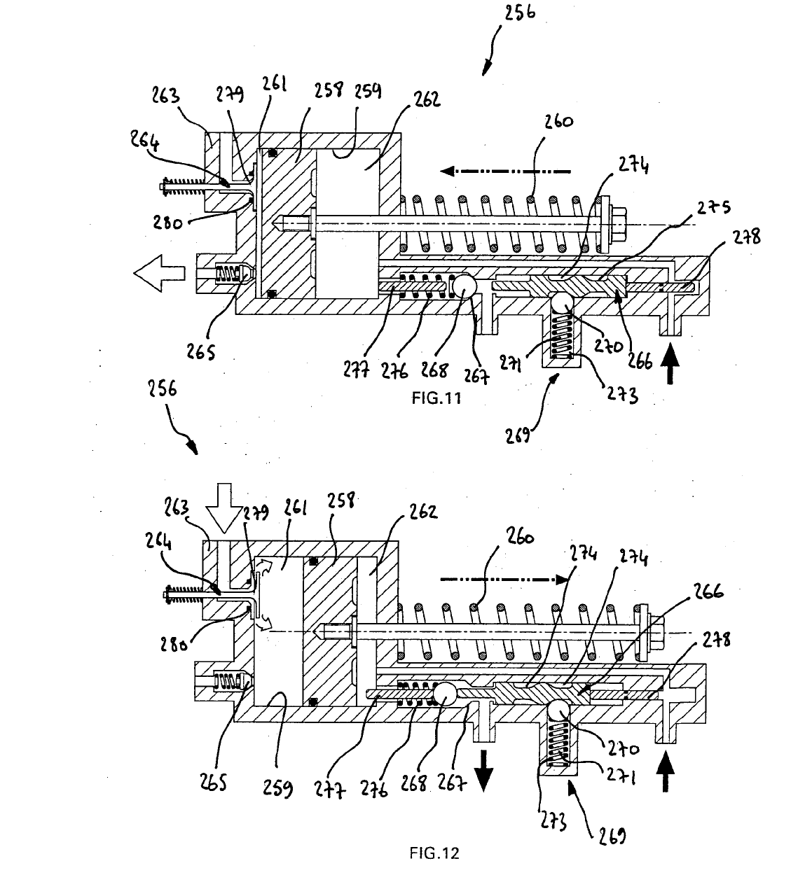

FIGS. 11 to 14 are views showing the various steps in the operation of the air pump of the hydraulic unit for a variable compression ratio engine according to the present invention.

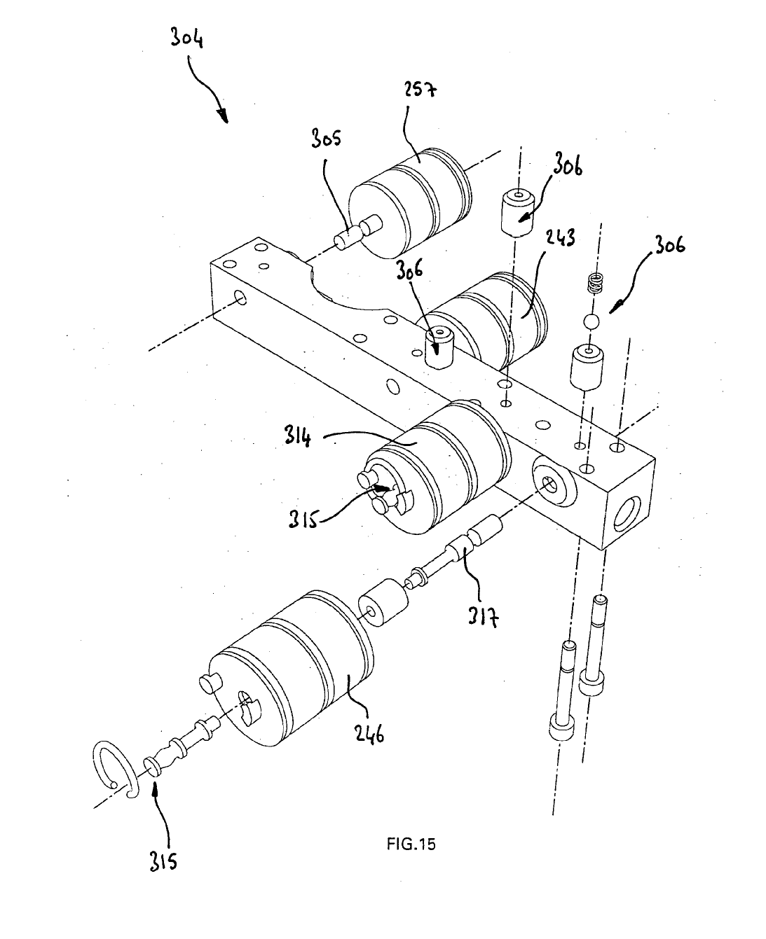

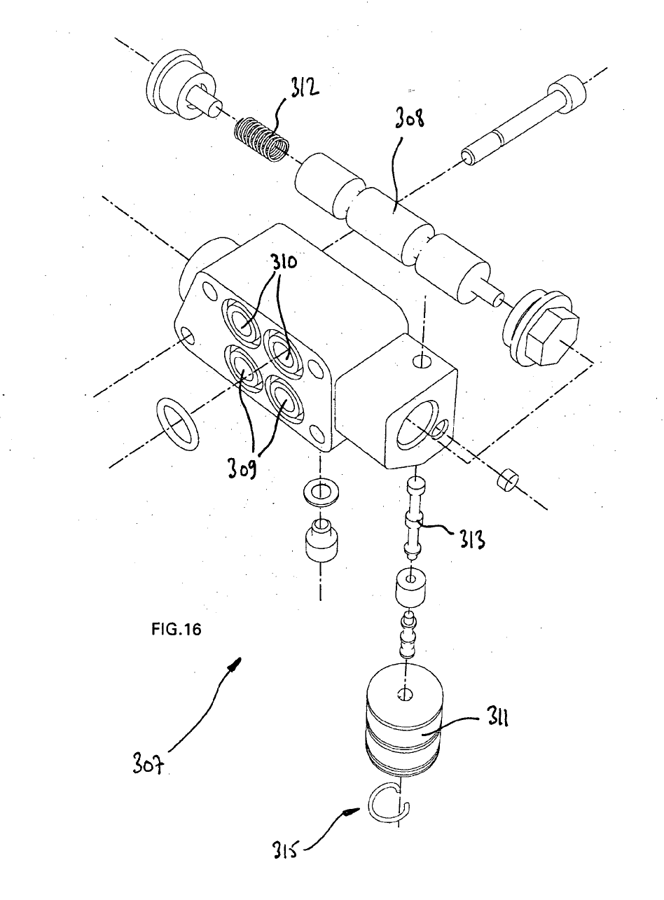

FIG. 15 is an exploded perspective view illustrating the resupply electrically operated valves and the common resupply rail of the hydraulic unit for a variable compression ratio engine according to the present invention.

FIG. 16 is an exploded perspective view showing the selection spool for selecting the inlet pressure for the control actuators of the hydraulic unit for a variable compression ratio engine according to the present invention.

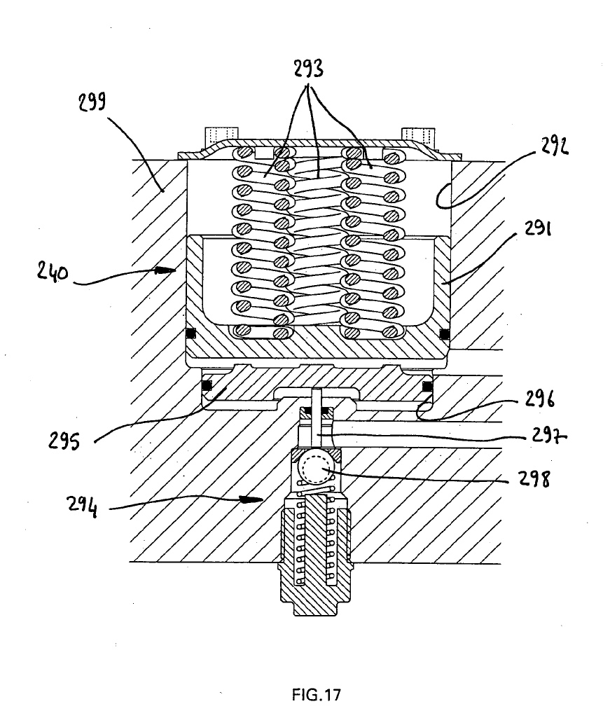

FIG. 17 is a view in section depicting the lubricating oil pressure accumulator of the hydraulic unit for a variable compression ratio engine according to the present invention.

FIG. 1 depicts an engine block 100 which comprises at least one cylinder 110 in which a piston 2 is moved by means of a transmission device 1, and pressure means which allow the main moving parts of a variable compression ratio engine to be kept in position in their crank case.

The mechanical transmission device 1 comprises, in the lower part of the piston 2, a transmission member 3 secured to said piston and collaborating, on the one hand, with an antifriction guidance device 4 and, on the other hand, with a cogged wheel 5.

The cogged wheel 5 collaborates with a connecting rod 6 connected to a crank shaft 9 so as to transmit movement between the piston 2 and said crankshaft. The cogged wheel 5 collaborates at the opposite side of the transmission member 3 with another rack known as the control rack 7, of which the vertical position with respect to the engine block 100 is controlled by a control device 12 comprising a control actuator 8, the actuator piston 13 of which is guided in an actuator cylinder 112 formed in the engine block 100.

The actuator cylinder 112 is closed at its top by an actuator cylinder head 113 which is screwed down onto the engine block 100.

The engine block 100 is secured to a support 41 comprising racks 46 which synchronize the movement of the roller 40 of the antifriction guidance device 4 to that of the piston 2.

A hydraulic unit 200 made up of various self-contained and independent components may be installed either inside the engine block 100 or at any point in the engine compartment of the vehicle or in the vehicle itself.

According to a preferred embodiment, the various components of the hydraulic unit 200 may be fully or partially housed in the sump 203 of the engine block 100.

FIGS. 2 to 6 show a hydraulic unit 200 for a variable compression ratio engine, the various components of which may be fully or partially housed in the sump 203 of the engine block 100.

The hydraulic unit 200 comprises a compressed air oil pressure accumulator 251 connected to the inlet of a multi-stage pressure amplifier 241 comprising at least one stage the outlet pressure of which is applied to the pressing actuator(s) 170 of said engine, said outlet pressure being controlled by at least one stage-selection electrically operated valve 285.

Likewise, the compressed air oil pressure accumulator 251 of the hydraulic unit 200 is connected to the control actuator(s) 8 of said engine.

The hydraulic unit 200 comprises at least one reserve of air under pressure 244 containing at least one pressure sensor 245 allowing the pressure in said reserve to be measured.

The reserve of air under pressure 244 comprises at least one air dump electrically operated valve, allowing the pressure in said reserve to be lowered.

According to one particular embodiment, this electrically operated dump valve may be replaced by a dump check valve which allows air to pass when the pressure exceeds a certain pressure and does so in order to limit the maximum pressure in the air reserve 244.

The reserve of air under pressure 244 of the hydraulic unit 200 for a variable compression ratio engine comprises at least one temperature sensor 248.

The hydraulic unit 200 comprises at least one oil reservoir 249 placed under pressure by the reserve of air under pressure 244.

The oil reservoir 249 of the hydraulic unit 200 for a variable compression ratio engine comprises an oil level sensor 250 allowing the amount of oil contained in said reservoir to be measured.

The measurement of the amount of oil contained in the oil reservoir 249 may be based on the microphone detection of the natural frequency of the volume of air set in vibration by an acoustic generator, or alternatively may be based on one or more resistors the electrical conductivity of which is measured, this being dependent on the temperature induced in them by the degree to which they are immersed in the oil.

The oil reservoir 249 comprises at least one pressure sensor allowing the pressure in said reservoir to be measured.

The oil level sensor 250 of the oil reservoir 249 of the hydraulic unit 200 consists of at least one float 252 connected to a position sensor 253.

The hydraulic unit 200 comprises at least one high-pressure oil pump 254 driven by the variable compression ratio engine, the supply of oil to said unit 200 from said oil pump 254 being controlled by a high-pressure oil pump electrically operated valve 255.

The hydraulic unit 200 for a variable compression ratio engine comprises at least one air pump 256, the outlet of which is connected to the reserve of air under pressure 244.

The air pump 256 of the hydraulic unit 200 is operated using oil from the high-pressure oil pump 254 when said oil is directed toward said air pump 256 by an air pump resupply electrically operated valve 257.

The hydraulic unit 200 for a variable compression ratio engine comprises a circuit separator 300 which comprises a separator piston 301 housed in a separation cylinder 302.

The circuit separator 300 comprises a separator piston 301 housed in a separation cylinder 302.

The circuit separator 300 prevents the oil contained in the variable compression ratio engine lubricating circuit and the oil contained in the oil reservoir 249 from mixing with the oil contained in the control actuator(s) 8 of said engine, but allows the oil contained in the variable compression ratio engine lubricating circuit or the oil contained in the oil reservoir 249 to impart its pressure to the oil contained in the circuit connected to the control actuator(s) 8 of said engine.

The circuit separator 300 comprises at least one sensor 303 allowing the position of the separating piston to be measured.

FIGS. 7 to 9 depict the multi-stage pressure amplifier 241 of the hydraulic unit 200 for a variable compression ratio engine.

The multi-stage pressure amplifier 241 comprises a multi-stage pressure amplifier casing 286, a multi-stage piston 281 collaborating, on the one hand, with at least one emitter cylinder 282 thus constituting a stage, connected either to the lubricating circuit of the variable compression ratio engine or to the oil reservoir 249 of the hydraulic unit 200 and, on the other hand, with a receiving cylinder 283 hydraulically connected to the pressing actuators 170 of said engine.

The multi-stage pressure amplifier 241 of the hydraulic unit 200 comprises at least one multi-stage piston deviation sensor 284 allowing the position of the multi-stage piston 281 to be measured.

The multi-stage pressure amplifier 241 comprises as many stage electrically operated valves 285 as it has stages, said stage electrically operated valves 285 each allowing their own stage to be connected either to the lubricating circuit of the variable compression ratio engine or to the oil reservoir 249 kept under pressure by the reserve of air 244 of the hydraulic unit 200.

The stage electrically operated valve(s) 285 of the multi-stage pressure amplifier 241 comprises a stage selection spool 287 allowing one or other of the two inlets thereof to be placed in communication with the outlet thereof, it not being possible for said two inlets to be placed simultaneously in communication with said outlet.

The stage selection spool 287 that the stage electrically operated valve 285 comprises is actuated in one direction by placing the first end of said spool in communication with the pressure in the lubricating circuit of said engine and in the other direction by means of a return spring 288 which exerts a force on the second end of said spool 287.

The stage electrically operated valve(s) 285 of the multi-stage pressure amplifier 241 comprise a small stage selection electrically operated valve spool 289 moved by the electromagnetic field produced non-simultaneously by two coils, the first coil serving to push said small spool 289, while the second serves to pull it, said small spool 289 being held in position when it reaches one or other of the ends of its travel by a locking device 315, said small spool 289 allowing the first end of the stage selection spool 287 to be placed in communication either with the pressure in the lubricating circuit of said engine, or with free air.

The stage selection spool 287 collaborates with a dump check valve 290 connecting the emitter cylinder 282 of its own stage with the circuit connected to the oil reservoir 249 of the hydraulic unit 200, said dump check valve 290 allowing the oil to proceed from said emitter cylinder 282 to said circuit when the pressure in said emitter cylinder 282 exceeds that of said circuit by a certain amount.

FIGS. 10 to 14 show the air pump 256 of the hydraulic unit 200 for a variable compression ratio engine which comprises a piston 258 moving in an air pump cylinder 259 formed in a casing 272.

The air pump piston 258 is returned by a return spring 260 and delimits, with the air pump cylinder 259, an air chamber 261 on the one hand, and an oil chamber 262 on the other.

The air chamber 261 is situated on the opposite side to the return spring 260 and allows air alternately to be drawn from outside the hydraulic unit 200 and then delivered into the reserve of air under pressure 244.

The oil chamber 262 is situated on the same side as the return spring 260 and is able alternately to receive oil under pressure from the oil pump 254 then deliver it into a sump 203 containing variable compression ratio engine lubricating oil by means of the return spring 260 of the air pump piston 258.

The air pump 256 comprises a cylinder head 263 which closes the air pump cylinder 259 formed in the casing 272 on the one hand, and the oil reservoir 249 on the other, said cylinder head 263 comprising an air intake valve 264 and an air outlet check valve 265 opening into the oil reservoir 249.

The air pump 256 comprises a two-position reversing shuttle 266 which allows a reversing ball 268 to be lifted off its seat 267 or set down on its seat 267. The reversing ball 268 is held on its seat 267 by a reversing spring 276. The reversing ball 268 collaborates with a contact point 277 which emerges into the air pump cylinder 259 in order to come into contact with the piston 258 of the air pump 256.

Thus, the first position of the reversing shuttle 266 forces the oil from the oil pump 254 to enter the oil chamber 262 (FIGS. 11, 13 and 14), while the second position of the reversing shuttle 266 allows the oil from the oil pump 254 and the oil contained in the oil chamber 262 to return to the sump 203 of variable compression ratio engine lubricating oil (FIG. 12).

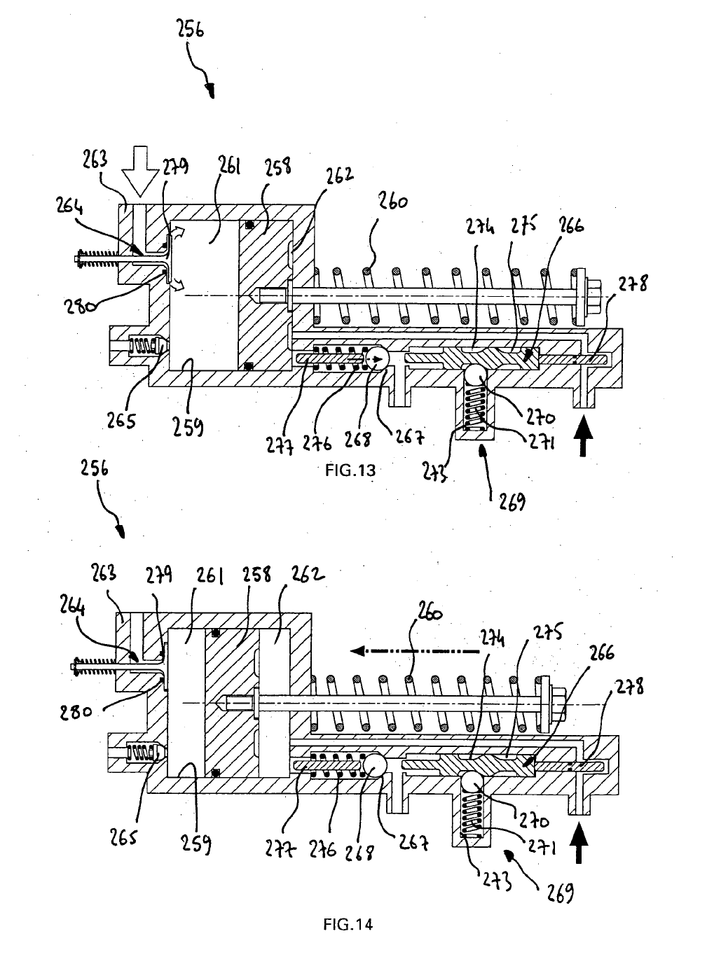

When the contact point 277 of the air pump 256 comes into contact with the piston 258, said contact point allows the reversing shuttle 266 to be pushed back via one of its ends so that the oil from the oil pump 254 is forced to enter the oil chamber 262 (FIG. 13).

On the opposite side to the contact point 277, the reversing shuttle 266 collaborates with a pressure rod 278 on the rear of which the pressure in the oil chamber 262 is exerted. The pressure rod 278 allows the reversing shuttle 266 to be pushed back via its other end so that the oil from the oil pump 254 and the oil contained in the oil chamber 262 can return to the sump 203 containing variable compression ratio engine lubricating oil (FIG. 12).

The reversing shuttle 266 of the air pump 256 is kept in one or other of its extreme positions by a locking device 269. The locking device 269 may consist of a locking ball 270 which is pushed by a locking spring 271, held in position in the casing of the air pump 256 by a bore 273 and becoming housed in a respective one of two grooves 274, 275 formed on the reversing shuttle 266.

It will be noted that the air admitted by the air intake valve 264 of the air pump 256 may come either from inside the crank case or engine block 100 of the variable compression ratio engine possibly via a device for separating the air from the oil, or from outside said engine via a duct known per se.

The air intake valve 264 of the air pump 256 comprises a large-diameter bell 279 which collaborates with an O-ring seal 280 in order on the one hand to reduce the pressure difference required to open said valve and, on the other hand, to increase the amount of oil admitted to the air chamber 261.

The air intake valve 264 of the air pump 256 allows air contained in the sump 203 of variable compression ratio engine lubricating oil to be admitted to the air chamber 261 via a device that allows the air to be separated from the oil.

FIG. 15 shows the resupply electrically operated valves 243, 246, 257, 314 and the common resupply rail 304 of the hydraulic unit 200 for a variable compression ratio engine.

The common resupply rail 304 allows the destination of the oil from the high-pressure pump 254 to be preselected, said rail comprising one inlet and at least one outlet.

The common resupply rail 304 comprises as many resupply electrically operated valves as it comprises outlets, said electrically operated valves having one inlet and one outlet.

The resupply electrically operated valves 243, 246, 257, 314 of the common resupply rail 304 consist of a small resupply spool moved by the electromagnetic field that can be produced non-simultaneously by two coils, the first coil serving to push said small spool, while the second serves to pull it, said small resupply spool being kept in position when it reaches one or other of the ends of its travel by a locking device 315.

The resupply electrically operated valves 243, 246, 257, 314 of the common resupply rail 304 each collaborate with at least one non-return check valve 306 positioned on the outlet side of said electrically operated valves.

Each non-return check valve 306 allows the resupply electrically operated valves 243, 246, 257, 314 to supply oil to the circuit situated downstream of them but prevents said oil contained in said circuit from returning to said electrically operated valves.

FIG. 16 shows a selection device 307 for selecting the inlet pressure of the control actuators 8 of the hydraulic unit 200 for a variable compression ratio engine.

The selection device 307 comprises a selection spool 308 for selecting the inlet pressure of the control actuators 8, said selection spool 308 being a two-position spool allowing one or other of its two inlets 309 to be placed in communication with its outlet 310.

The first position allows the circuit connected to the control actuator(s) 8 of the engine to be placed in pressure communication with the oil reservoir 249 of the hydraulic unit 200 pressurized by the reserve of air 244.

The second position allows the circuit connected to the control actuator(s) 8 of the engine to be placed in pressure communication with the lubricating circuit of said engine.

The selection spool 308 which selects the inlet pressure of the control actuators 8 that the selection electrically operated valve 311 comprises is actuated in one direction by placing the first end of said spool in communication with the pressure in the lubricating circuit of said engine and in the other direction by means of a return spring 312 which exerts a force on the second end of said spool 308.

The selection electrically operated valve 311 comprises a small selection spool 313 moved by the electro-magnetic field produced non-simultaneously by two coils, the first coil serving to push said small spool 313 while the second serves to pull it, said small spool 313 being held in position when it reaches one or other of the ends of its travel by a locking device 315, said small spool 313 allowing the first end of the selection spool 308 that selects the inlet pressure for the control actuators 8 to be placed in communication either with the pressure in the lubricating circuit of said engine or with free air.

FIG. 17 shows the lubricating oil pressure accumulator 240 of the hydraulic unit 200 for a variable compression ratio engine.

The lubricating oil pressure accumulator 240 makes it possible to damp the variations in pressure caused by the operation of the hydraulic unit 200 in the engine lubricating circuit.

The lubricating oil pressure accumulator 240 consists of an accumulator piston 291 moving in an accumulator cylinder 292 and kept pressed against the oil that the accumulator cylinder 292 contains by at least one spring 293.

The hydraulic unit 200 comprises, in conjunction with the lubricating oil pressure accumulator 240, an oil outlet unlocking device 294 which prevents the oil from leaving the oil reservoir 249 when the variable compression ratio engine is not running.

The oil outlet unlocking device 294 consists of an unlocking piston 295 housed in an unlocking cylinder 296 subjected to the pressure of said engine lubricating oil.

The unlocking piston 295 can push on an unlocking rod 297 in order to lift an unlocking ball 298 off its seat so that the pressure in the oil reservoir 249 can be passed on to the hydraulic circuits connected to the control actuators 8 on the one hand, and to the pressing actuators 170 on the other.

The accumulator piston 291 of the lubricating oil pressure accumulator 240 and the unlocking piston 295 of the oil outlet unlocking device 294 are mounted in one and the same cylinder formed in the accumulator casing 299.

It will be noted that the reserve of air 244, the reserve of oil 249, the lubricating oil pressure accumulator 240, the oil outlet locking device 294 and the circuit separator 300 may all, or some of them, be formed in one and the same machined component.

This one same component may have been precast and have various surfaces onto which the cylinder head of the air pump 263, the air pump 256, and the multi-stage amplifier 241 are screwed. Because of the contact between the air and the oil in a hydraulic unit 200 according to the invention, and to prevent an accumulation of air in the control actuators 8, these actuators may have a degassing device which has not been depicted.

By way of nonlimiting example, this degassing device may consist of a cut made in the control rod of the control actuators 8, allowing a deliberate leakage of air and oil contained in the upper chamber of the control actuators 8 through the upper seal of the control rod and toward the crank case 100 of the engine, when the compression ratio of the engine is low.

It will be noted that this degassing device, which has not been depicted, may also be supplemented or replaced by a control actuator 8 overpressure dump check valve (not depicted) which, as the temperature of the variable compression ratio engine rises, prevents the expansion of the oil contained in the control actuator(s) 8 from causing an excessive increase in the pressure in said actuators.

In this respect, said dump check valve is designed to allow the oil contained in the control actuator(s) 8 to escape to the sump 203 containing the lubricating oil of said engine when the pressure in the chamber of said actuators exceeds a certain value.

It will be observed that this check valve may advantageously be replaced by a simple nozzle to replace the leak compensation nonreturn check valve provided on the control actuator(s) 8 of the variable compression ratio engine, said nonreturn check valve having been described in the earlier patent applications in the name of the same applicant.

### Hydraulic Unit Operation:

According to one particular embodiment, the hydraulic unit 200 operates as follows:

The reserve of air 244 of the hydraulic unit according to the invention has been previously pressurized, at the workshop, during assembly of the variable compression ratio engine.

The pressure contained in said reserve of air 244 is exerted on the oil contained in the oil reservoir 249 of the hydraulic unit 200. When the variable compression ratio engine is started up, because the lubricating pump known per se of said engine starts to turn, the pressure in the lubricating oil pressure accumulator 240 increases and the lubricating oil exerts a force on the unlocking piston 295 of the hydraulic unit 200.

The unlocking piston 295 then pushes on its unlocking rod 297 and lifts the unlocking ball 298 which was hitherto held on its seat by a spring, the effect of this being to release the pressure contained in the oil reservoir 249 and apply it to the inlet of the multi-stage pressure amplifier 241 on the one hand, and to the inlet of the selection spool 308 that selects the inlet pressure of the control actuators 8 on the other.

Because of the unlocking that has just been described, the hydraulic unit 200 becomes operational to apply the desired hydraulic pressure to the control actuators 8 and to the pressing actuators 170 of the variable compression ratio engines.

Most of the operating points of the variable compression ratio engine requires a high pressure to be exerted on the inlet of its control actuator(s) 8. This pressure is needed both to increase the stiffness of the oil contained in said control actuator(s) 8 in order to improve the precision with which they are able to maintain their datum position, and also to prevent any risk of cavitation in the chambers of said actuators 8, and to assist them with their movement aimed at improving the compression ratio of the variable compression ratio engine.

However, there are certain transient operating points of the variable compression ratio engine which, by contrast, require a lower pressure to be applied to the inlet of the control actuators 8, it being possible for said pressure to be substantially equal to the pressure in the pressurized lubricating circuit of said engine.

In such cases, the engine control unit ECU will instruct the selection spool 308 that selects the inlet pressure of the control actuators 8 to change position in order to switch over its outlet pressure, something that said selection spool 308 does by placing the control actuators 8 not in communication with the oil reservoir 249 of the hydraulic unit 200 pressurized by the reserve of air 244 but now with the lubricating circuit of said engine.

It will be noted that in order to achieve this result, and according to one particular embodiment of the hydraulic unit 200 according to the invention, the engine control unit ECU applies an electrical voltage, as appropriate, to one or other of the coils of the selection electrically operated valve 311, said selection electrically operated valve 311 thereby constituting the first stage in the control of the selection device 307 that selects the inlet pressure of the control actuators 8.

The effect of this is to apply or to cancel the pressure exerted by the engine lubricating oil on the end of said selection spool 308 so that this spool moves into the desired position. It will be observed that the selection spool 308 is returned by means of a spring 312 which applies to said spool a force that opposes the force that could be exerted by said engine lubricating oil.

It will also be noted that, according to one particular embodiment, the hydraulic unit 200 according to the invention may comprise a circuit separator 300 which incorporates a separating piston 301 preventing the air-saturated oil contained in the oil reservoir 249 of said unit from mixing with the oil contained in the circuit of the control actuators 8 of the variable compression ratio engine.

In this case, the oil contained in the oil reservoir 249 of the hydraulic unit 200 or, as the case may be, the oil contained in the variable compression ratio engine lubricating circuit, exerts a pressure on a first face of the separating piston 301, said piston passing this pressure on in full and in a fluidtight manner to the oil contained in the circuit connected to the control actuators 8 by means of its second face.

The pressure applied to the pressing actuators 170 needs to vary according to the speed and load of the variable compression ratio engine. This becomes necessary because of variations in the force applied to the parts of the moving linkages of said engine, which require a greater or lesser force exerted by the pressing actuators 170 in order to limit the acoustic emissions of said engine.

In order to obtain a variation in the pressure in the chamber of the pressing actuator(s) 170 of the engine, the various inlet stages of the multi-stage amplifier 241—termed emitter cylinders 282—may be subjected independently either to the low pressure in the engine lubricating circuit or to the high pressure in the oil reservoir 249 of the hydraulic unit 200 according to the invention.

The various inlet stages of the multi-stage amplifier 241—termed emitter cylinders 282—collaborate to provide the desired pressure for the pressing actuators 170 by combining their thrusting force, the sum of these forces being applied via the multi-stage piston 281 to a receiver cylinder 283 connected hydraulically to the pressing actuators 170 of the engine.

It will be noted that it is advantageous to ensure that the cross section of each stage is equal to twice the cross section of the next stage. Using this strategy and by way of nonlimiting example, if the first stage of a four-stage multi-stage amplifier 241 has a cross section of one cm², the second stage will have a cross section of two cm², the third of four and the fourth of eight cm².

With this nonlimiting arrangement it is possible, by combining stages which either are or are not subjected to low or high pressure, to obtain sixteen pressure levels that can be applied to the pressing actuators 170, the values of said pressure levels being evenly distributed on a straight line connecting the minimum value to the maximum value of pressure.

According to this nonlimiting example, when the control unit ECU of the variable compression ratio engine wishes to apply any one of the sixteen pressure values to the pressing actuators 170 of said engine, it applies an electrical voltage to one or other of the coils of the electrically operated valve 285 which controls the position of the corresponding stage selection spools 287 that need to have either a low pressure or high pressure applied to their stage. The effect of this is to apply or to cancel the pressure exerted by the engine lubricating oil on the end of said stage selection spools 287 to make them move into the desired position.

It will be noted in this respect that, as is also the case of the selection spool 308 that selects the inlet pressure of the control actuators 8, the stage selection spools 287 each comprise two coils actuating a stage selection electrically operated valve small spool 289 that has two positions rendered stable by a locking device 315.

The first coil adopts the function of pushing said stage selection electrically operated valve small spool 289 and the second the function of pulling it. In a first position, the small spool 289 places the end of the stage selection spool 287 in communication with the lubrication pressure of the variable compression ratio engine so that said spool 287 moves into and remains in a first position, whereas in the second position, the small spool 289 places the end of the stage selection spool 287 in communication with free air.

In the latter case, the stage selection spool 287 is returned by a spring 288 which applies a force to the opposite end of said stage selection spool 287 to the end on which the lubrication pressure may or may not be applied depending on the position of the small spool 289.

It will also be noted that during operations of the stage selection spool 287, the corresponding stage may find itself closed again for a brief period, even though the pressing actuators 170 are subjected to variations in pressure caused by the operation of the variable compression ratio engine.

For this reason, each stage selection spool 287 collaborates with a dump check valve 290 connecting the chamber of its stage to the circuit connected to the oil reservoir 249 of the hydraulic unit 200 according to the invention. This dump check valve 290 is designed to open as soon as the pressure in the chamber of the stage to which it is connected becomes excessively higher than the pressure of the oil reservoir 249 of the hydraulic unit 200.

It will also be noted that as the stage selection spools 287 are operated, the volume of the variable compression ratio engine lubrication circuit varies.

This observation may also be made when the control actuators 8 are placed in communication with the engine lubricating circuit by the selection spool 308 that selects the inlet pressure of the control actuators 8 and said control actuators 8 are operated to modify the compression ratio of said engine.

In order to avoid any failure to lubricate the moving parts of the variable compression ratio engine as a result of these variations in volume, the lubricating oil pressure accumulator 240 is designed to compensate for said variations in volume, and thereby avoid any sudden drop or increase in lubrication pressure that would be detrimental to correct lubrication of said engine.

The foregoing description of the operation assumes no leaks either of air or of oil, something which in practice in the case of the hydraulic unit 200 according to the invention cannot be achieved. Because of this, the hydraulic unit 200 according to the invention has various sensors 245, 248, 250, 284, 303 able to detect a lack of air or oil as a result of inevitable leaks that arise in the circuits of said hydraulic unit 200, whether this be the circuit of the control actuators 8 and/or the circuit of the pressing actuators 170.

These sensors 245, 248, 250, 284, 303 collaborate with a device for resupplying oil and air that said hydraulic unit 200 according to the invention incorporates. It will be noted that the oil is supplied by a high-pressure oil pump 254 similar or identical to the one described in French patent application FR 2 896 539 in the name of the same applicant.

With this configuration, the oil pump 254 may be driven by any one of the camshafts of the variable compression ratio engine and be switched into the circuit by a high-pressure oil pump electrically operated valve 255.

The resupply with air is the province of an air pump 256 incorporated into the hydraulic unit 200 according to the invention. If the control unit ECU of the variable compression ratio engine detects insufficient pressure in the reserve of air 244 of the hydraulic unit 200 using an air pressure sensor 245, and taking account of the air temperature which is transmitted to said control unit via an air temperature sensor 248, the control unit ECU will order the resupplying of the hydraulic unit 200 with air.

To do that, it will order the air pump 256 to be switched into circuit by applying an electrical voltage to one of the coils of the air pump electrically operated valve 257 the air pump resupply spool 305 of which lies in the common resupply rail 304.

Said voltage will open the oil supply circuit of the air pump 256, the other resupply circuits remaining closed. The control unit ECU will then order that the high-pressure pump 254 situated at the end of the camshaft be switched into circuit as described previously. These two combined actions will have the effect of operating the air pump 256 of the hydraulic unit 200.

The air pump 256 operates as follows: oil from the high-pressure oil pump 254 is introduced—via the common resupply rail 304—into the oil chamber 262 of the air pump 256 situated behind the piston 258 of said air pump, so that said piston will move and at low speed compress the air contained in the air chamber 261 of said air pump 256 which is situated in front of the piston 258 of said air pump 256.

When the piston 258 comes to close to its top dead center position, the pressure of the air contained in the air chamber 261 becomes higher than that of the air contained in the reserve of air 244 of the hydraulic unit 200. The air therefore lifts the air outlet check valve 265 which allows it to pass from the air chamber 261 of the air pump 256 to the reserve of air 244 of the hydraulic unit 200 and to do so until such point as the piston 258 of the air pump 256 comes into contact with its cylinder head 263.

When the piston 258 of said air pump 256 comes into contact with the cylinder head 263, the pressure in the oil chamber 262 of the air pump 256 rises sharply and this has the effect of increasing the force applied by the pressure rod 278 on the reversing shuttle 266 of the air pump, and of creating a condition such that its locking device 269 is no longer able to keep said reversing shuttle 266 in position.

The reversing shuttle 266 therefore changes position and its locking device 269 engages to keep it in this position.

As a result, the reversing shuttle 266, which hitherto allowed the reversing ball 268 to force the oil from the high-pressure pump 254 to remain in the oil chamber 262 of the air pump 256, now keeps said reversing ball 268 away from its seat 267, thus freeing the oil contained in the oil chamber 262 so that it is expelled into the sump 203 containing the variable compression ratio engine lubricating oil under the action of the return spring 260 of the piston 258 of the air pump 256, with the oil from the high-pressure pump 254.

The first effect of this is to return the piston 258 of the air pump 256 to its bottom dead center position and the second effect is to cause said piston 258 to suck in a new charge of air which is introduced into the air chamber 261 of the air pump 256 via the air intake valve 264 of said air pump 256.

When the piston 258 of the air pump 256 nears its bottom dead center position under the action of its return spring 260, said piston comes into contact with the contact point 277 of the reversing shuttle 266.

The contact point 277, under the action of the return spring 260 of the piston 258 of the air pump 256, is forced to push the reversing shuttle 266 back so that it returns to its initial position and allows the reversing ball 268 to rest once again on its seat 267.

The locking device 269 of the reversing shuttle 266 once again keeps said shuttle in a position such that the reversing ball 268 remains firmly seated on its seat 267, that the oil from the high-pressure oil pump 254 is once again forced to remain in the oil chamber 262 of the air pump 256, and that the air now trapped in the air chamber 261 of the air pump 256 is progressively compressed in order once again to be able to be introduced into the reserve of air 244 of the hydraulic unit 200 of the invention.

This cyclic operation of the air pump 256 is sustained by the control unit ECU of the variable compression ratio engine as long as the air pressure datum in the reserve of air 244 is not reached, said datum value being detected by said control unit ECU by means of the air pressure sensor 245.

To compensate for other leaks, the hydraulic unit 200 according to the invention also has other devices allowing it to resupply the various reservoirs and circuits of said hydraulic unit 200 with oil.

It will be observed that the oil reservoir 249 of the hydraulic unit 200 notably comprises an oil level sensor 250 which may consist of a float 252 the vertical position of which is measured by means of a position sensor 253.

If the control unit ECU of the variable compression ratio engine detects that the oil level in the oil reservoir 249 is too low, making allowances for any oil that may normally be stored in the control actuators 8 of said engine, or making allowances for oil lost in the circuit of the control actuators 8 or that of the pressing actuators 170, said control unit ECU will order the resupplying of the oil reservoir 249 of the hydraulic unit 200 with oil.

To do that, the control unit ECU will order the oil reservoir 249 to be switched into circuit by applying an electrical voltage to one of the coils of the resupply electrically operated valve 314 of the oil reservoir 249, the resupply spool of which is located in the common resupply rail 304.

Said voltage will open the circuit for resupplying the oil reservoir 249 with oil, the other resupply circuits remaining closed. The control unit ECU will then, by means of the high-pressure oil pump electrically operated valve 255, order the high-pressure pump 254 situated at the end of the camshaft to be switched into circuit as described earlier.

These two combined actions will have the effect of resupplying said oil reservoir 249 with oil, via its resupply spool, said spool being mounted in series with a nonreturn check valve 306. This resupply is sustained by the control unit ECU of the variable compression ratio engine as long as the oil level datum for the oil reservoir 249 has not been reached and the sensor 253 relating to the float 252 has not returned the desired value to said control unit ECU.

It will also be noted that the hydraulic unit 200 according to the invention comprises a deviation sensor 284 sensing the deviation of the multi-stage piston 281 of the multi-stage pressure amplifier 241 and which may consist of a position sensor capable of measuring the position of said piston of said amplifier.

If the control unit ECU of the variable compression ratio engine detects that, following oil leaks that have arisen in the pressing actuator(s) 170 of the variable compression ratio engine, the position of the multi-stage piston 281 has deviated and is exceeding its maximum permissible position, said control unit ECU will order the resupplying of the pressing actuators 170 of the hydraulic unit 200 according to the invention with oil.

To do that, the control unit ECU will order the circuit of the pressing actuators 170 to be placed in communication with that of the high-pressure oil pump 254 by applying an electrical voltage to one of the coils of the resupply electrically operated valve 243 of the pressing actuators 170, the resupply spool of which is situated in the common resupply rail 304.

Said electrical voltage will open the circuit for supplying the circuit of the pressing actuators 170 with oil, the other resupply circuits remaining closed.

Next, the control unit ECU will order that the high-pressure oil pump 254 situated at the end of the camshaft be switched into circuit as described previously. These two combined actions will have the effect of resupplying the circuit of the pressing actuators 170 with oil via its corresponding resupply spool, said spool being mounted in series with a nonreturn check valve 306. This resupply is sustained by the control unit ECU of the variable compression ratio engine as long as the position datum of the multi-stage piston 281 is not reached and as long as the deviation sensor 284 that senses deviation of said multi-stage piston 281 has not returned the desired value to the control unit ECU.

The hydraulic unit 200 according to the invention also comprises a deviation sensor 303 for the separator piston 301 of the circuit separator 300 which isolates the circuit connected to the oil reservoir 249 of said unit from the one connected to the control actuator(s) 8 of the variable compression ratio engine. The deviation sensor 303 may notably consist of a metal rod 318 secured to the separating piston 301 and inserted inside an induction coil able to measure the position of said separator piston 301 of the circuit separator 300.

If the control unit ECU of the variable compression ratio engine detects that, as a result of oil leaks that have occurred at the control actuator(s) 8 of the variable compression ratio engine, the position of the separator piston 301 has deviated and is exceeding its maximum permissible position bearing in mind the position of the control actuators 8, said control unit will order the resupplying of the circuit of the control actuators 8 of said engine with oil.

To do that, it will order that the circuit of the control actuators 8 be placed in communication with that of the high-pressure oil pump 254 by applying an electrical voltage to one of the coils of the resupply electrically operated valve 246 of the control actuators 8 the resupply spool 317 of which is positioned in the common resupply rail 304.

Said electrical voltage will open the circuit for supplying the circuit of the control actuators 8 with oil, the other resupply circuits remaining closed. The control unit ECU will then order that the high-pressure oil pump 254 situated at the end of the camshaft be switched into circuit as described previously.

These two combined actions will have the effect of resupplying the circuit of the control actuators 8 with oil via their resupply spool 317, said spool being mounted in series with a nonreturn check valve 306. This resupply is sustained by the control unit ECU of the variable compression ratio engine as long as the position datum for the separator piston 301 of the circuit separator 300 has not been reached and as long as the deviation sensor 303 relating to the separator piston 301 has not returned the desired value to said control unit ECU.

Furthermore, it must be understood that the foregoing description has been given merely by way of example and does not in any way restrict the field of the invention and that replacing embodiment details described with any other equivalent would not constitute departure from the field of the invention.

1. A hydraulic unit for a variable compression ratio engine, said engine comprising an engine block (100) provided with at least one cylinder (110) in which a piston (2) is moved by means of a transmission device (1) and pressure means consisting, inter alia, of one or more pressing actuator(s) (170), characterized in that it comprises a compressed air oil pressure accumulator (251) connected, on the one hand, to the inlet of a multi-stage pressure amplifier (241) comprising at least one stage and the outlet pressure of which is applied to the pressing actuator(s) (170) of said engine, said outlet pressure being controlled by at least one stage selection electrically operated valve (285), and connected, on the other hand, to the control actuator(s) (8) of said engine.

2. The hydraulic unit for a variable compression ratio engine as claimed in claim 1, characterized in that the compressed air oil pressure accumulator (251) comprises at least one reserve of air under pressure (244).

3. The hydraulic unit for a variable compression ratio engine as claimed in claim 2, characterized in that the reserve of air under pressure (244) comprises at least one pressure sensor (245) allowing the pressure in said reserve to be measured.

4. The hydraulic unit for a variable compression ratio engine as claimed in claim 2, characterized in that the reserve of air under pressure (244) comprises at least one electrically operated air dump valve allowing the pressure in said reserve to be lowered.

5. The hydraulic unit for a variable compression ratio engine as claimed in claim 2, characterized in that the reserve of air under pressure (244) comprises at least one temperature sensor (248).

6. The hydraulic unit for a variable compression ratio engine as claimed in claim 2, characterized in that the compressed air oil pressure accumulator (251) comprises at least one oil reservoir (249) placed under pressure by the reserve of air under pressure (244).

7. The hydraulic unit for a variable compression ratio engine as claimed in claim 6, characterized in that the oil reservoir (249) comprises an oil level sensor (250) allowing the amount of oil contained in said reservoir to be measured.

8. The hydraulic unit for a variable compression ratio engine as claimed in claim 6, characterized in that the oil reservoir (249) comprises at least one pressure sensor allowing the pressure in said reservoir to be measured.

9. The hydraulic unit for a variable compression ratio engine as claimed in claim 7, characterized in that the oil level sensor (250) consists in at least one float (252) the vertical position of which is measured by a position sensor (253).

10. The hydraulic unit for a variable compression ratio engine as claimed in claim 1, characterized in that it comprises at least one high-pressure oil pump (254) driven by the variable compression ratio engine, the supply of oil to said hydraulic unit (200) from said oil pump (254) being controlled by a high-pressure oil pump electrically operated valve (255).

11. The hydraulic unit for a variable compression ratio engine as claimed in claim 2, characterized in that it comprises at least one air pump (256), the outlet of which is connected to the reserve of air under pressure (244).

12. The hydraulic unit for a variable compression ratio engine as claimed in claim 11, characterized in that the air pump (256) is operated using oil from the high-pressure oil pump (254) when said oil is directed toward said air pump (256) by an air pump electrically operated valve (257).

13. The hydraulic unit for a variable compression ratio engine as claimed in claim 12, characterized in that the air pump (256) comprises a piston (258) moving in an air pump cylinder (259), said piston (258) being returned by a return spring (260) and delimiting with the air pump cylinder (259) an air chamber (261) on the one hand, and an oil chamber (262) on the other, the air chamber (261) being situated on the opposite side to the return spring (260) and allowing air to be alternately drawn from outside the hydraulic unit (200) then delivered into the reserve of air under pressure (244), while the oil chamber (262) is situated on the same side as the return spring (260) and is able alternately to receive oil under pressure from the oil pump (254) and then deliver it to a sump (203) containing variable compression ratio engine lubricating oil by means of the return spring (260) of the air pump piston (258).

14. The hydraulic unit for a variable compression ratio engine as claimed in claim 11, characterized in that the air pump (256) comprises a cylinder head (263) which closes the air pump cylinder (259) on the one hand, and the oil reservoir (249) on the other, said cylinder head (263) comprising an air intake valve (264) and an air outlet check valve (265) opening into the oil reservoir (249).

15. The hydraulic unit for a variable compression ratio engine as claimed in claim 11, characterized in that the air pump (256) comprises a two-position reversing shuttle (266) able to lift a reversing ball (268) off its seat (267) or set it down on its seat (267), the first position forcing the oil from the oil pump (254) to enter the oil chamber (262), the second position allowing the oil from the oil pump (254) and the oil contained in the oil chamber (262) to return to the sump (203) of variable compression ratio engine lubricating oil.

16. The hydraulic unit for a variable compression ratio engine as claimed in claim 15, characterized in that the two-position reversing shuttle (266) is kept in one or other of its extreme positions by a locking device (269).

17. The hydraulic unit for a variable compression ratio engine as claimed in claim 15, characterized in that the air pump (256) comprises, on the one hand, a contact point (277) that comes into contact with the piston (258) and is able to push the reversing shuttle (266) back via one of its ends so that the oil from the oil pump (254) is forced to enter the oil chamber (262) and, on the other hand, a pressure rod (278) on the rear of which the pressure in the oil chamber (262) is exerted, said pressure rod (278) being able to push said reversing shuttle (266) back via its other end so that the oil from the oil pump (254) and the oil contained in the oil chamber (262) can return to the sump (203) of variable compression ratio engine lubricating oil.

18. The hydraulic unit for a variable compression ratio engine as claimed in claim 11, characterized in that the air pump (256) comprises at least one air intake valve (264).

19. The hydraulic unit for a variable compression ratio engine as claimed in claim 11, characterized in that the air pump (256) comprises at least one air outlet check valve (265) opening into the reserve of air under pressure (244).

20. The hydraulic unit for a variable compression ratio engine as claimed in claim 18, characterized in that the air intake valve (264) comprises a large-diameter bell (279) which collaborates with an O-ring seal (280) in order on the one hand to reduce the pressure difference required to open said valve and, on the other hand, to increase the amount of air admitted to the air chamber (261).

21. The hydraulic unit for a variable compression ratio engine as claimed in claim 18, characterized in that the air intake valve (264) allows air contained in the sump (203) of variable compression ratio engine lubricating oil to be admitted to the air chamber (261) via a device (316) that allows the air to be separated from the oil.

22. The hydraulic unit for a variable compression ratio engine as claimed in claim 1, characterized in that the multi-stage pressure amplifier (241) comprises a multi-stage amplifying casing (286), and a multi-stage piston (281) collaborating, on the one hand, with at least one emitter cylinder (282) formed in said casing (286) which communicates either with the variable compression ratio engine lubricating circuit or with the oil reservoir (249) of said unit and, on the other hand, with a receiving cylinder (283) which communicates hydraulically with the pressing actuators (170) of said engine.

23. The hydraulic unit for a variable compression ratio engine as claimed in claim 22, characterized in that the multi-stage pressure amplifier (241) comprises at least one deviation sensor (284) allowing the position of the multi-stage piston (281) to be measured.

24. The hydraulic unit for a variable compression ratio engine as claimed in claim 1, characterized in that the multi-stage pressure amplifier (241) comprises as many stage electrically operated valves (285) as it does stages, said stage electrically operated valves (285) each allowing their own stage to be placed in communication either with the variable compression ratio engine lubricating circuit or with the oil reservoir (249) kept under pressure by the reserve of air under pressure (244) belonging to said unit.

25. The hydraulic unit for a variable compression ratio engine as claimed in claim 24, characterized in that the stage electrically operated valve(s) (285) of the multi-stage pressure amplifier (241) comprise a stage selection spool (287) allowing one or other of the two inlets of said stage electrically operated valve(s) (285) to be placed in communication with their outlet, it not being possible for said two inlets to be placed simultaneously in communication with said outlet.

26. The hydraulic unit for a variable compression ratio engine as claimed in claim 25, characterized in that the stage selection spool (287) that the stage electrically operated valve (285) comprises is actuated in one direction by placing the first end of said spool in communication with the pressure in the lubricated circuit of said engine and in the other direction by means of a return spring (288) which exerts a force on the second end of said spool (287).

27. The hydraulic unit for a variable compression ratio engine as claimed in claim 26, characterized in that the stage electrically operated valve(s) (285) of the multi-stage pressure amplifier (241) comprise a small stage selection electrically operated valve spool (289) moved by the electromagnetic field produced non-simultaneously by two coils, the first coil serving to push said small spool (289), while the second serves to pull it, said small spool (289) being held in position when it reaches one or other of the ends of its travel by a locking device (315), said small spool (289) allowing the first end of the stage selection spool (287) to be placed in communication either with the pressure in the lubricating circuit of said engine, or with free air.

28. The hydraulic unit for a variable compression ratio engine as claimed in claim 26, characterized in that the stage selection spool (287) collaborates with a dump check valve (290) connecting the emitter cylinder (282) of its own stage with the circuit connected to the oil reservoir (249) of the hydraulic unit (200), said dump check valve (290) allowing the oil to proceed from said emitter cylinder (282) to said circuit when the pressure in said emitter cylinder (282) exceeds that of said circuit by a certain amount.

29. The hydraulic unit for a variable compression ratio engine as claimed in claim 1, characterized in that it comprises a lubricating oil pressure accumulator (240) for damping the variations in pressure caused by the operation of said hydraulic unit (200) in the lubricating circuit of said engine.

30. The hydraulic unit for a variable compression ratio engine as claimed in claim 29, characterized in that the lubricating oil pressure accumulator (240) consists of an accumulator piston (291) moving in an accumulator cylinder (292) and kept pressed against the oil said cylinder contains by at least one spring (293).

31. The hydraulic unit for a variable compression ratio engine as claimed in claim 30, characterized in that it comprises an oil outlet unlocking device (294) which prevents the oil from leaving the oil reservoir (249) when said engine is not running.

32. The hydraulic unit for a variable compression ratio engine as claimed in claim 31, characterized in that the oil outlet unlocking device (294) consists of an unlocking piston (295) housed in an unlocking cylinder (296) subjected to the pressure of lubricating oil of said engine, said unlocking piston (295) being able to push on an unlocking rod (297) so as to lift an unlocking ball (298) off its seat so that the pressure in the oil reservoir (249) can be passed on to the hydraulic circuits connected to the control actuators (8) on the one hand, and the pressing actuators (170) on the other.

33. The hydraulic unit for a variable compression ratio engine as claimed in claim 32, characterized in that the accumulator piston (291) of the lubricating oil pressure accumulator (240) and the unlocking piston (295) of the oil outlet unlocking device (294) are mounted in one and the same cylinder.

34. The hydraulic unit for a variable compression ratio engine as claimed in claim 1, characterized in that it comprises a circuit separator (300) which comprises a separating piston (301) housed in a separating cylinder (302), said circuit separator (300) preventing the oil contained in the variable compression ratio engine lubricating circuit and the oil contained in the oil reservoir (249) from mixing with the oil contained in the control actuator(s) (8) of said engine, but allowing the oil contained in the variable compression ratio engine lubricating circuit or the oil contained in the oil reservoir (249) to impart its pressure to the oil contained in the circuit connected to the control actuator(s) (8) of said engine.

35. The hydraulic unit for a variable compression ratio engine as claimed in claim 34, characterized in that the circuit separator (300) comprises at least one deviation sensor (303) allowing the position of the separating piston (301) to be measured.

36. The hydraulic unit for a variable compression ratio engine as claimed in claim 1, characterized in that it comprises a common resupply rail (304) allowing the destination of the oil from the high-pressure oil pump (254) to be preselected, said rail having one inlet and at least one outlet.

37. The hydraulic unit for a variable compression ratio engine as claimed in claim 36, characterized in that the common resupply rail (304) comprises as many resupply electrically operated valves (243, 246, 257, 314) as it comprises outlets, said resupply electrically operated valves (243, 246, 257, 314) having one inlet and one outlet.

38. The hydraulic unit for a variable compression ratio engine as claimed in claim 37, characterized in that the resupply electrically operated valves (243, 246, 257, 314) of the common resupply rail (304) comprise a small resupply spool (305, 317) moved by the electromagnetic field that can be produced non-simultaneously by two coils, the first coil serving to push said small spool, while the second serves to pull it, said small spool being kept in position when it reaches one or other of the ends of its travel by a locking device (315).

39. The hydraulic unit for a variable compression ratio engine as claimed in claim 37, characterized in that the resupply electrically operated valves (243, 246, 257, 314) of the common resupply rail (304) each collaborate with at least one non-return check valve (306) placed on the outlet side of said electrically operated valves, said check valve allowing said electrically operated valves to supply oil to the circuit situated downstream of them but preventing said oil contained in said circuit from returning to said resupply electrically operated valves (243, 246, 257, 314).

40. The hydraulic unit for a variable compression ratio engine as claimed in claim 1, characterized in that it comprises a device (307) for selecting the inlet pressure of the control actuators (8), said selection device (307) comprising a selection spool (308).

41. The hydraulic unit for a variable compression ratio engine as claimed in claim 40, characterized in that the selection spool (308) which selects the inlet pressure of the control actuators (8) is a two-position spool allowing one or other of its two inlets (309) to be placed in communication with its outlet (310), the first position allowing the circuit connected to the control actuator(s) (8) of the engine to be placed in pressure communication with the oil reservoir (249) of the hydraulic unit (200) placed under pressure by the reserve of air (244), the second position allowing the circuit connected to the control actuator(s) (8) of the engine to be placed in pressure communication with the lubricating circuit of said engine.

42. The hydraulic unit for a variable compression ratio engine as claimed in claim 40, characterized in that the selection spool (308) which selects the inlet pressure of the control actuators (8) that the selection electrically operated valve (311) comprises is actuated in one direction by placing the first end of said spool in communication with the pressure in the lubricating circuit of said engine and in the other direction by means of a return spring (312) which exerts a force on the second end of said spool (308).

43. The hydraulic unit for a variable compression ratio engine as claimed in claim 42, characterized in that the selection electrically operated valve (311) comprises a small selection spool (313) moved by the electromagnetic field produced non-simultaneously by two coils, the first coil serving to push said small spool (313) while the second serves to pull it, said small spool (313) being held in position when it reaches one or other of the ends of its travel by a locking device (315), said small spool (313) allowing the first end of the selection spool (308) that selects the inlet pressure for the control actuators (8) to be placed in communication either with the pressure in the lubricating circuit of said engine or with free air.
